(19) United States
(12) Patent Application Publication
(10) Pub. No.: US 2010/0153667 A1
(43) Pub. Date: Jun. 17, 2010

(54) METHOD, COMPUTER PROGRAM AND ELECTRONIC DEVICE

(75) Inventors: Stefan Andersson, Klagerup (SE); Marcus Liwell, Malmo (SE); Werner Johansson, Arlov (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/408,779

(22) Filed: Mar. 23, 2009

Related U.S. Application Data
(60) Provisional application No. 61/122,491, filed on Dec. 15, 2008.

(51) Int. Cl. G06F 12/16; G06F 12/14

(52) U.S. Cl. 711/162; 711/163; 711/E12.103; 711/E12.091; 713/324

(57) ABSTRACT

A method for utilizing a secure memory in an electronic device for launching/running an application may include copying at least a portion of the application into the secure memory of the electronic device, and permanently storing the at least one portion of the application in the secure memory. The permanent storage of the at least one portion of the application in the secure memory obviates the need re-copy the application to the secure memory if/when the application is subsequently executed by the electronic device.

### TECHNICAL FIELD

The present invention generally relates to a method for utilizing a secure memory in an electronic device for launching/running an application. The present invention also concerns a computer program and an electronic device.

### BACKGROUND OF THE INVENTION

Electronic devices, such as mobile telephones, often require access to security-related components, such as application programs, cryptographic keys, intermediate cryptographic calculation results, passwords, authentication means for externally downloaded data, or other software or data. Typically, these components and the processing of these components should be kept confidential within the electronic device to prevent the device being accessed by an unauthorized party.

Accordingly, many electronic devices include a secure execution environment in which a processor within the electronic device is able to access the security-related components. The security-related components are usually handled, processed, and managed alongside applications and components that do not require any secure processing. Many electronic devices thus include both a secure execution environment and a non-secure execution environment, in which latter case the processor of the electronic device has no access to the security-related information within the electronic device. When an application is being launched/run, a processor within the electronic device will normally access both security-related components in the secure execution environment and components in the non-secure execution environment.

When an application that is stored in a non-volatile memory, such as a NAND flash memory, of an electronic device is launched, the electronic device's operating system will cause application files (e.g., consisting of program code) to be read from the non-volatile memory. The application files are then temporarily copied to a secure memory in the secure execution environment, such as a RAM memory, from which the program code will subsequently be executed. The application is run from the secure memory and the application files in the secure memory are then automatically deleted therefrom once the application has been run or when the electronic device is switched off. A copy of the application does, however, remain in the non-volatile memory of the electronic device should a user subsequently wish to run the application again, whereupon application files will again be temporarily copied to the secure memory and deleted therefrom once the application has been run (or when the electronic device is switched off).

Since the application files must be copied to the secure memory each time an application is launched, launching the application will always be slightly delayed. Launching an application in the manner described above also requires an electronic device to have a relatively sophisticated operating system, which is CPU and memory intensive. The associated costs involved in developing such an operating system furthermore increase the cost of electronic devices in which such an operating system resides.

### SUMMARY OF THE INVENTION

An aspect of the invention is to address and/or minimize at least one of the disadvantages mentioned above, and/or to provide a useful alternative. A further aspect of the present invention is to provide an efficient way of using an electronic device's secure memory for initiating and/or executing an application.

At least one of these aspects may be achieved by a method that includes the steps of: a) copying at least one part of the application into the secure memory of the electronic device, and b) permanently storing the at least one part of the application in the secure memory, whereby the permanent storage of the at least one part of the application in the secure memory thereby obviates the need to copy the at least one part of the application into the secure memory if and/or when the application is subsequently run. The secure memory therefore provides a secure application program code cache.

The at least one part of an application may only be copied to the secure memory of an electronic device only once, irrespective of how many times the application is subsequently run from the secure memory. An application may consequently be launched more quickly, since there is no delay due to a user waiting for at least one part of an application to be copied into the secure memory. Furthermore, there is no need to provide an electronic device with a complex operating system to control the operation of a processor in the electronic device and to process application programs (by assigning storage space in the secure memory and controlling input and output functions). An operating system may therefore be completely omitted or, alternatively, included in a much more simple form than the operating systems used in conventional electronic devices that use a secure memory to only temporarily store applications or application components.

The expression “at least one part of the application” is intended to mean at least one security-related component of an application, such as an application file, program code, a cryptographic key or algorithm, intermediate cryptographic calculation results, passwords, authentication means for externally downloaded data, and/or other software or data.

The expression “permanently storing the at least one part of the application in the secure memory” is intended to mean that the at least one part of the application is not deleted once, or shortly after, the application has been run, but instead remains in the secure memory (even after the electronic device has been switched off) until the user decides to delete the at least one part of the application from the secure memory.

It should be noted that the steps of copying and permanently storing at least one part of an application, above steps a) and b), need not necessarily be two separate steps but at least one part of an application may be permanently stored in the secure memory as it is being copied thereto.

According to an embodiment of the invention, a method may include the step of scanning the secure memory for the at least one part of the application before step a), to check whether it is already stored therein and, if so, omitting steps a) and b). Application program code is not unnecessarily re-copied to the secure memory if it is already contained therein. Any new data associated with the application may, however, be copied to the secure memory, so if the same application is run a plurality of times, the secure memory will contain only one instance of the application's program code, but multiple instances of data. If the secure memory does not already contain the at least one part of the application, steps a) and b) of the method may be executed. The scanning step may involve comparing an application identification and/or image with application identifications and/or images that are already stored in the secure memory.

It should be noted that the same application and/or application component need not be re-copied to the secure memory, however, if an application and/or application component has been updated or modified since it was previously copied into the secure memory, then the electronic device may be arranged to update and/or modify the application and/or application component that is stored in the secure memory, by replacing that which is stored with an updated and/or modified version.

According to another embodiment of the invention, a method may include the step of verifying the at least one part of the application before step a) is executed, to ensure that the at least one part of the application has not been altered during its transmission from a non-volatile memory within the electronic device to the secure memory, for example.

According to another embodiment of the invention, a method may include the step of decrypting the at least one part of the application before step a) is executed, whereby decrypted data is stored in the secure memory, thereby allowing for a quicker application launch.

According to a further embodiment of the invention, a method may include the step of asking a user whether the user wishes to delete a permanently-stored application and/or application component from the secure memory of the electronic device, and/or asking the user to confirm that the user wishes to permanently store an application and/or application component in the secure memory, before step b) is executed.

According to an embodiment of the invention, an electronic device may include a mobile telephone, a media player, a personal communications system (PCS) terminal, a personal data assistant (PDA), a palmtop receiver, a camera, a television, and/or any electronic device in which associated software and/or data is to be protected.

The present invention also relates to a computer program product that includes a computer program containing computer-readable program code means arranged to cause a processor to execute the steps of a method according to any of the embodiments of the invention, stored on one or more computer-readable storage devices and/or a carrier wave.

The present invention further relates to an electronic device, a mobile telephone, a media player, a PCS terminal, a PDA, a palmtop receiver, a camera, a television, and/or any electronic device in which associated software and/or data is to be protected. The electronic device comprises a secure memory, such as a RAM memory, that is dedicated to storing security-related components in a secure execution environment of the electronic device. The electronic device may include a processor arranged to copy at least one part of an application into the secure memory. The processor may be arranged to permanently store the at least one part of the application in the secure memory, whereby the permanent storage of the at least one part of the application in the secure memory obviates re-copying it into the secure memory if and/or when the application is subsequently run.

According to an embodiment of the invention, an electronic device may include a scanner to scan previously-stored applications in the secure memory, to determine whether the at least one part of the application is already stored therein, whereby the processor is arranged to copy the at least one part of the application into the secure memory only when it is determined that the application is not already stored in the secure memory. The scanner may be arranged to compare an application identification or image with application identifications and/or images that are already stored in the secure memory.

According to a further embodiment of the invention, a processor may be arranged to verify and/or authenticate the at least one part of the application before step a) is executed.

According to an embodiment of the invention, a processor may be arranged to decrypt the at least one part of the application before step a) is executed.

It should be noted that a processor of the electronic device according to the present invention, may be realized in one or more processors, whereby one or more functions of a processor need not necessarily be carried out by one and the same processor.

A skilled person will realize that the hardware contained in an electronic device according to the present invention typically executes appropriate software to perform the steps of a method according to an embodiment of the present invention.

### BRIEF DESCRIPTION OF THE DRAWINGS

The present invention will hereinafter be further explained by means of non-limiting examples with reference to the appended schematic figures where:

FIG. 1 shows exemplary steps of a method according to an embodiment of the invention; and

FIG. 2 shows an exemplary electronic device according to an embodiment of the invention.

It should be noted that the drawings have not necessarily been drawn to scale and that the dimensions of certain features may have been exaggerated for the sake of clarity.

### DETAILED DESCRIPTION OF EMBODIMENTS

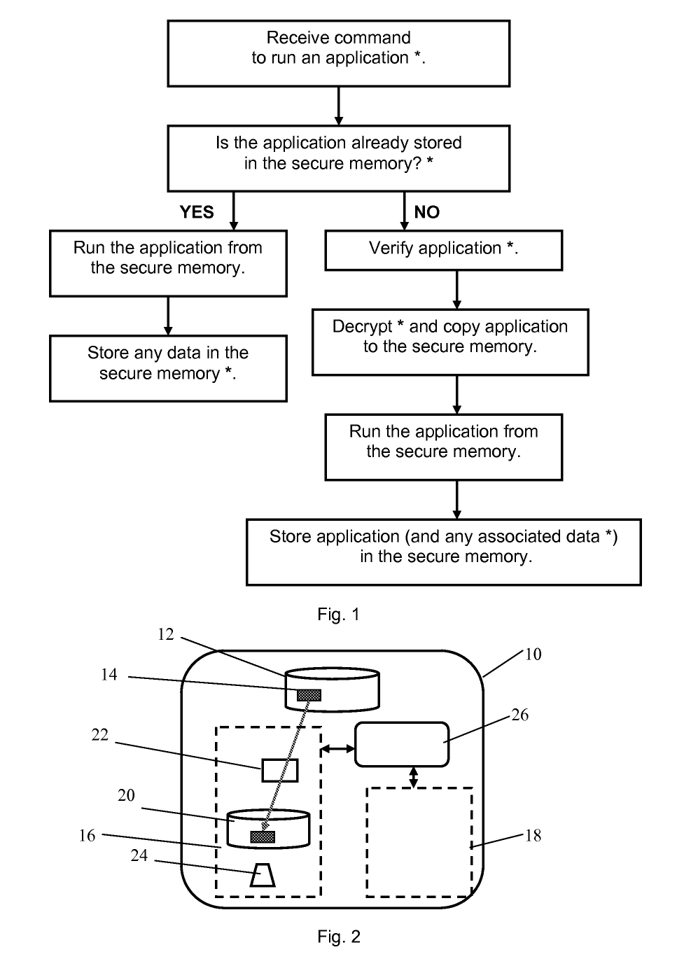

FIG. 1 shows a method according to an embodiment of the invention. The method may be performed by an electronic device and include the steps of receiving a command to launch and/or run a particular application. The electronic device may be configured to determine whether the particular application is already stored in a secure memory of the electronic device, for example, by comparing an application identification and/or image corresponding to the particular application with application identifications and/or images corresponding to respective ones of a plurality of applications that are already stored in the secure memory.

If the particular application is determined to already be stored in the secure memory, the particular application may initiated and/or executed from the secure memory, and any new data associated with the current running of the particular application may be stored in the secure memory for subsequent access.

If the particular application is determined to not already be stored in the secure memory, the particular application, e.g., application program code, may be read either from a non-volatile memory, such as a NAND flash memory within or external to the electronic device, and/or another source within and/or external to the electronic device. The particular application may, for example, be downloaded into the secure memory of an electronic device from an external file server via a data network. The integrity of the application program code may be verified to ensure that it has not been altered during transmission from its source to the electronic device, e.g., written to the secure memory.

Upon verification, the application may be (automatically and/or on confirmation from a user) copied to the secure memory of the electronic device and run/launched therefrom. For example, the application may be decrypted before it is storing in the secure memory.

The application and any (new) data associated with the running of the application may not be deleted from the secure memory once the application has been executed, but instead permanently stored in the secure memory, whereby the application (and any data) need not be re-copied into the secure memory of the electronic device if and/or when the application is subsequently executed.

Method steps shown in FIG. 1 and marked with an asterisk (*) are exemplary, and need not necessarily be carried out when launching/running an application from the secure memory of the electronic device.

FIG. 2 schematically shows an electronic device 10, such as a mobile telephone, that may include an internal non-volatile memory, such as a NAND flash memory in which applications 14 and/or application components may be stored. Electronic device 10 may include a secure execution environment 16, which may control the downloading and execution of security-related components of applications, and a non-secure execution environment 18. Secure execution environment 16 may include a removable smart card, such as a SIM card.

Secure execution environment 16 may include a secure memory 20, such as a RAM memory for the storage of security-related data and applications 14 and a first processor 22 that is used to perform verification of any application software/data that is to be stored in secure memory 20, whereby only verified software and/or data has access to secure execution environment 16. For example, first processor 22 may be configured to decrypt application software and/or data before it is stored in secure memory 20. Electronic device 10 also may include a scanner 24 that is used to determine whether application 14 and/or application component is already stored in secure memory 20 when electronic device 10 receives a command to launch and/or run particular application 14.

Electronic device 10 also may include a second processor 26 and means to place second processor 26 in a secure mode of operation and/or a non-secure mode. Second processor 26 may be capable of accessing and communicating with security components in secure execution environment 16 when operating in a secure mode, and accessing and communicating only with components in non-secure execution environment 18 when operating in a non-secure mode. After application 14 has been executed, it may be permanently stored in secure memory 20 for subsequent use.

If a user wishes to play an encrypted music file on electronic device 10, processor 26 may enter a secure mode of operation to decrypt the music file using a decryption key stored in secure memory 20 in secure execution environment 16 and then enter a non-secure mode to play the decrypted music file in non-secure execution environment 18. At the same time, a user can decrypt and play a video file on electronic device 10, whereby processor 26 may be configured to decrypt the video file in secure execution environment 16 while the decrypted music file is being played in non-secure execution environment 18. Different multiple applications may therefore be run concurrently. An associated time delay may accompany initial storing of security-related components of applications 14 in secure memory 20 of electronic device 10, but once these components have been stored in secure memory 20, the user will subsequently be able to launch (stored) applications 14 without an associated time delay.

Secure execution environment 16 may, of course, include other elements, such as a ROM memory containing boot application software that includes the main functionality of the electronic device and optionally, an operating system, a further RAM memory, flash memory, and/or additional processors (none of which are shown in FIG. 2).

Further modifications of the invention within the scope of the claims would be apparent to a skilled person.

What is claimed is:

1. A method of using a secure memory of an electronic device in launching/running a particular application by the electronic device, the method comprising:
copying at least a portion of the particular application to the secure memory; and
permanently storing the at least a portion of the particular application in the secure memory,
where, when the particular application is subsequently initiated, the at least a portion of the particular application in the secure memory is not copied again to the secure memory.

2. The method of claim 1, further comprising:
scanning the secure memory for the at least a portion of the particular application before the copying at least a portion of the particular application to the secure memory;
determining that the at least a portion of the particular application is already stored in the secure memory; and
bypassing performing of the copying the at least a portion of the particular application to the secure memory and the permanently storing the at least a portion of the particular application in the secure memory.

3. The method of claim 2, where the scanning includes comparing at least one of an application identification or an image indicative of the at least a portion of the particular application with at least one of a plurality of application identifications or a plurality of images stored in the secure memory indicative of a plurality of applications.

4. The method of claim 1, further comprising:
verifying the at least a portion of the particular application before performing the copying the at least a portion of the particular application to the secure memory.

5. The method of claim 1, further comprising:
decrypting the at least a portion of the particular application before performing the copying the at least a portion of the particular application to the secure memory.

6. The method of claim 1, where the electronic device is a mobile telephone, a media player, a personal communications system (PCS) terminal, a personal data assistant (PDA), a palmtop receiver, a camera, or a television.

7. The method of claim 1, further comprising:
powering down the electronic device; and
powering up the powered down electronic device and initiating the at least a portion of the particular application without re-copying the at least a portion of the particular application to the secure memory.

8. The method of claim 1, further comprising:
not copying other portions of the particular application to the secure memory, where the other portions of the particular application are related to a non-secure execution environment.

9. A computer-readable memory device comprises a computer program containing a set of instructions to cause a processor in an electronic device to:
copying at least a portion of a particular application to a secure memory of the electronic device; and
permanently storing the at least a portion of the particular application in the secure memory,
where, when the particular application is subsequently initiated, the at least a portion of the particular application in the secure memory is not copied again to the secure memory.

10. An electronic device comprising:
a secure memory; and
a processor to copy at least one part of an application to the secure memory for permanent storage and obviate a need to ever re-copy the at least one part of an application to the secure memory when the at least one part of an application is subsequently executed by the electronic device.

11. The electronic device of claim 10, further comprising:
a scanner to scan a plurality of stored applications in the secure memory to determine whether a copy of the application exists in the secure memory, where the processor is to copy the at least one part of the application into the secure memory only when the copy of the application is not in the secure memory.

12. The electronic device of claim 11, where the scanner is to compare at least one of an application identification or an image corresponding to the application with at least one of application identifications or images corresponding to the plurality of stored applications.

13. The electronic device of claim 10, where the processor is to verify the at least one part of the application before the copying of at least one part of an application to the secure memory.

14. The electronic device of claim 10, where the processor is to decrypt the at least one part of the application before the copying of at least one part of an application to the secure memory.

15. The electronic device of claim 10, where the electronic device is a mobile telephone, a media player, a personal communications system (PCS) terminal, a personal data assistant (PDA), a palmtop receiver, a camera, or a television device.

16. The electronic device of claim 10, where the permanent storage comprises retention of the at least one part of the application in the secure memory when the electronic device is shut off.

17. The electronic device of claim 10, where the permanent storage comprises deletion of the at least one part of the application from the secure memory upon receiving a user input via a user interface of the electronic device.
